(19) United States
(12) Patent Application Publication
(10) Pub. No.: US 2007/0214354 A1
(43) Pub. Date: Sep. 13, 2007

(54) AUTHENTICATION SYSTEM EMPLOYING USER MEMORIES

(76) Inventor: Martin Renaud, Maple Ridge (CA)

Correspondence Address: PERKINS COIE LLP;PATENT-SEA, P.O. BOX 1247, SEATTLE, WA, 98111-1247, US

(21) Appl. No.: 11/608,186

(22) Filed: Dec. 7, 2006

Related U.S. Application Data
(60) Provisional application No. 60/782,114, filed on Mar. 13, 2006.

(51) Int. Cl. H04L 9/00

(52) U.S. Cl. 713/155

(57) ABSTRACT

An electronic access security method includes posing multiple categories to a user, where each category relates to a personal event that the user may recall, and providing several questions for a user-selected personal event category, where each question includes multiple corresponding choices. The method also includes storing the received selection of one of the personal event categories and the received choices of the one of the multiple choices, where the stored received selection and received choices are associated with the user.

### CROSS REFERENCE TO RELATED APPLICATION(S)

This application claims priority to U.S. Provisional Patent Application No. 60/782,114, filed 13 Mar. 2006, entitled PRESENCE OF MIND AUTHENTICATION SYSTEM.

### BACKGROUND

Security systems exist to help protect valuable electronic information, to restrict access to confidential areas, and to otherwise secure virtual or physical locations. Many existing security systems employ one of three security models: (1) using information that the user knows (e.g., login name and password), (2) using something the user has (e.g., a smart card or token), or (3) using something physical about the user (e.g., the user's fingerprint, iris, voice pattern, etc.). Security systems have become increasingly important for government and commercial systems for a variety of reasons. As an example, in the financial services industry it is increasingly important to prevent unauthorized access to a user's account. Because of the particular importance of security to the financial services industry, financial institutions have recently been required to employ two-factor authentication (security under two of the three models) to secure financial accounts.

Problems exist with each of the above three security models. For example, users often forget their user name or passwords. Passwords can also be easily stolen, and resetting passwords can be labor intensive and costly. Physical tokens are not only expensive, but also can be lost or forgotten. Mass adoption of physical tokens can be difficult because user resistance is high, and users may require separate tokens for each financial institution. The maintenance and tracking of physical tokens is even more labor intensive and costly than it is for passwords. Biometric systems are quite costly, impractical for many users/locations, and those that are less costly tend to be less secure.

These same shortcomings are equally applicable to securing hardware devices such as mobile phones, personal digital assistants (PDAs), laptops, etc. Incorporating biometric systems into these hardware devices raises the cost of the devices. Passwords and tokens may be used, but the shortcomings noted above apply.

Overall, there is a need in the marketplace for an authentication system that is as simple and fast to use as passwords, and that can also assure not merely the presence of a user's login information (username, password, token, etc.) but the presence of the user. Not only is such enhanced security required by financial institutions, but law enforcement, military, and other security applications desire low cost security systems that still provide the high security benefits of the systems noted above.

### BRIEF DESCRIPTION OF THE DRAWINGS

FIG. 1 is a block diagram of a computer that may employ aspects of an authentication system.

FIG. 2 is a block diagram illustrating a computing system in which aspects of the authentication system may operate in a networked environment.

FIGS. 3-10 are representative display screens showing one embodiment of the invention.

FIG. 11 is a flow diagram illustrating suitable steps performed under the embodiment of FIGS. 3-10.

FIGS. 12-22 are display screens showing an alternative embodiment to that shown in FIGS. 3-10.

### DETAILED DESCRIPTION

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

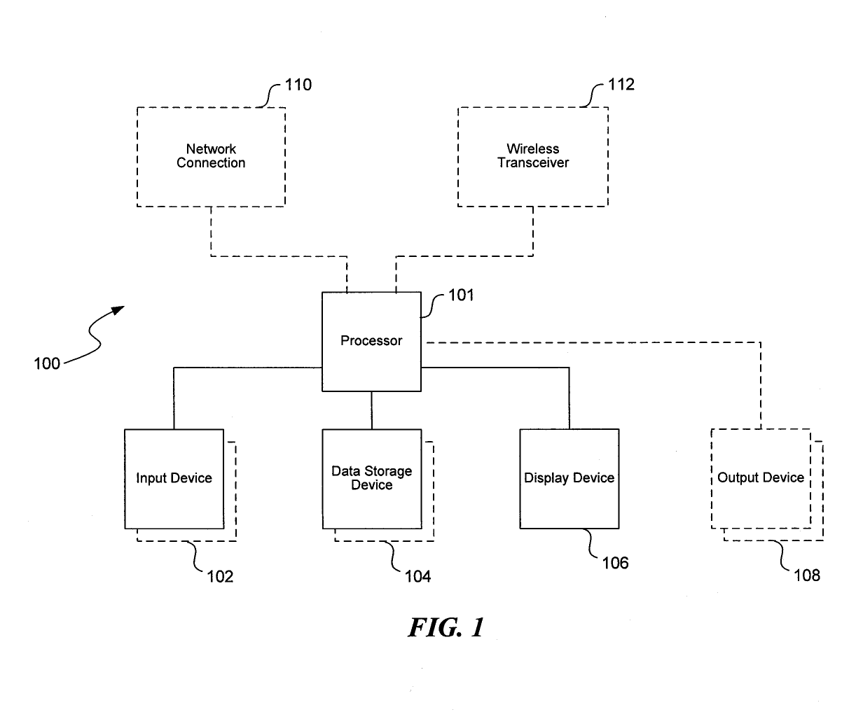

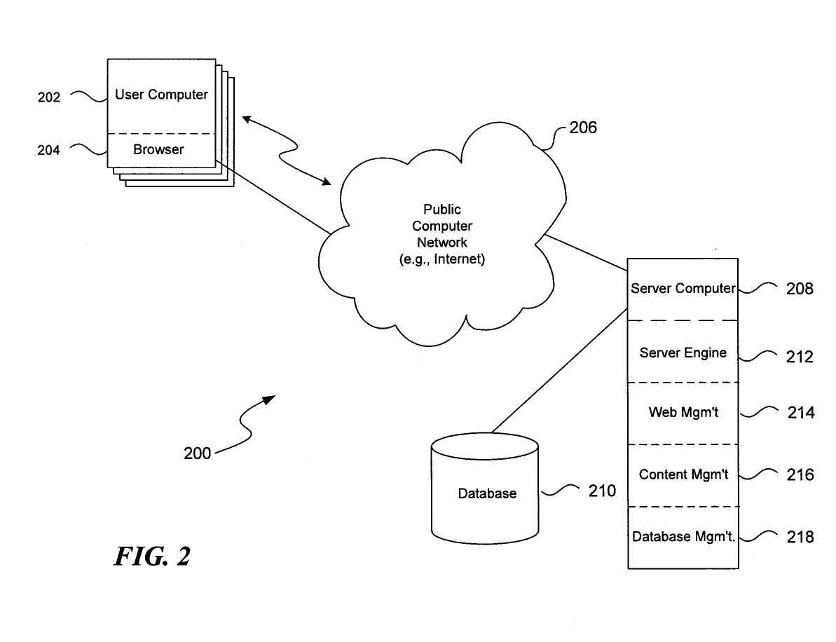

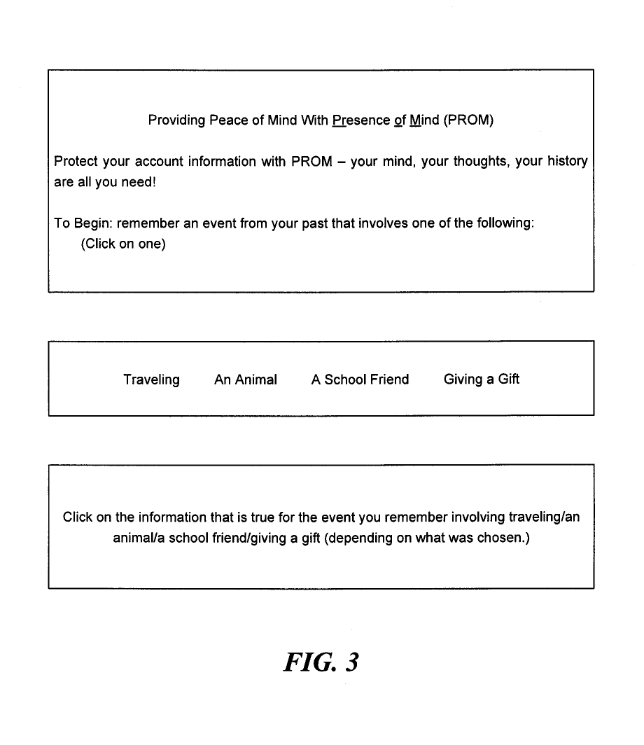

A representative computing environment will first be described below with respect to FIGS. 1 and 2. Thereafter, a suitable implementation and overview of this system is presented, followed by an example of an initial session of the system with respect to FIGS. 3-11. A discussion of subsequent authentications, alternatives and conclusions then follows.

### I. Representative Computing Environment

FIG. 1 and the following discussion provide a general description of a suitable computing environment or system in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and may be coupled to one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).As will become apparent below, aspects of the invention may be applied to any data processing device. For example, a mobile phone may be secured with only the addition of software stored within the device—no additional hardware is required, such as a hardware token or a biometric input system. The software may be stored within non-volatile memory of the phone, possibly even within the subscriber identity module (SIM) of the phone, or stored within the wireless network.

Aspects of the invention may be practiced in a variety of other computing environments. For example, referring to FIG. 2, a distributed computing environment including one or more user computers 202 in a system 200 are shown, each of which includes a browser module 204. Computers 202 may access and exchange data over a computer network 206, including over the Internet with web sites within the World Wide Web. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical or other user interface to users may be employed.

At least one server computer 208, coupled to the network 206, performs much or all of the functions for receiving, routing and storing of electronic messages, such as web pages, audio signals, and electronic images. While a public network is shown, a private network, such as an intranet may be preferred in some applications. The network may have a client-server architecture, in which a computer is dedicated to serving other client computers, or it may have other architectures such as a peer-to-peer, in which one or more computers serve simultaneously as servers and clients. A database 210 or other storage area coupled to the server computer(s) stores much of the web pages and content exchanged with the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216, and a database management component 218. The server engine performs basic processing and operating system level tasks. The web page management component handles creation and display or routing of web pages. Users may access the server computer by means of a URL associated therewith. The content management component handles most of the functions in the embodiments described herein. The database management component handles storage and retrieval tasks with respect to the database, queries to the database, and storage of data such as video, graphics and audio signals.

### II. Suitable Implementation and Overview

One embodiment of the invention, described in detail below, is sometimes referred to as PROM—(PResence Of Mind), which is a computer-implemented system having a user interface to capture information about events that the user may have experienced. In an initialization phase, a user enters information related to a particular theme that he or she is familiar with. The theme may be a life event that the user has personally experienced, a category of information that is known to the user, a well-known event that the user is likely to be familiar with, or any other set of information that the user would be able to consistently recollect. The user's familiarity with the theme is captured using a querying system, such as one that generates queries about the five main components of a theme: who, what, when, why, and where. Responses to the queries are entered by a user using a mouse-over event, mouse click, keyboard entry, number selection, or other user input mechanism (e.g. touch screen, voice recognition). The user's responses to the queries are stored in a user profile. The user is subsequently authenticated if the user is able to replicate the information stored about a theme in the user profile.

During an initialization phase (“introduction”), users enter responses to queries about a single theme with which they are familiar. During an authentication session (“recognition”), users are shown a subset of their previous responses within a list of distracters (described below). Positive authentication of the user results if the user is able to correctly identify the responses corresponding to the theme. The disclosed authentication system retains the user-facing simplicity and low cost of passwords, while gracefully introducing as much person-presence assurance as is required by the service or application.

As described below, in some embodiments during the initialization phase users are presented with a randomly chosen theme related to a common life event that the user may have experienced. The users are instructed to remember a vivid past event in their lives. Users are asked a sequence of questions pertaining to the life event and, for each question, are presented with a set of potential responses. Users respond to each question by selecting a response from the set of relevant responses that is true for the remembered event. The set of relevant responses may be displayed to the user in the form of a linear vertical grid, or in another form that allows the user to quickly identify an appropriate response. Each response selected by the user may be used to generate the next question and list of potential responses, allowing the system to quickly record a set of user-entered responses corresponding to the remembered event. The set of user responses are stored by the system in a profile associated with the user. Users may be asked to perform the initialization phase more than once so as to establish a profile containing responses to two or more themes. The themes may be related to one-another in content, or may have dissimilar content.

The user may select a theme and enter responses to subsequent questions related to the theme by keystrokes, mouse clicks or simply by passing a mouse over an appropriate area of the interface. The actual selection mechanism will depend upon the input device being employed by the user, or available by the given data processing device, which could run the gamut from automated teller machines to mobile telephones to desktop computers. The ease of use and simplicity of the interface enables the system to be readily applied to any device through which a person could be authenticated. While different devices will offer more or less control over interaction and will vary with respect to the quantity and quality of “cognometric” feedback they can provide, the approach is the same.

Additionally, during the initialization phase the system may request one or more words corresponding to the penultimate question about the theme. During authentication of the user, the user may be asked for whole word answers in response to the penultimate question. To be authenticated, the user's authentication session response must match the user's initialization phase response. Adding an additional authentication component augments the security achieved by the system through a single login session. Other authentication measures may also be employed to augment the security for exceptionally sensitive or potentially compromised situations.

In some embodiments, as a user is responding to questions the system may record multiple forms of information pertaining to the user, including content of responses, cursor movement patterns (direction and duration/speed), thematic choice patterns (propensities for choosing some themes over others), keystroke generation patterns, etc. Response patterns recorded by the system in this fashion may also be stored in a user's profile and used to provide a heightened level of security by checking that subsequent response patterns of the user match the stored response patterns. A single login session provides information on the user's past experience and on how that information is used in the present during a login session.

In some embodiments, the initialization (or introduction) phase may employ a confirmation step of all of the responses related to a particular theme that are provided by the user. The user is shown a vertical list of themes on the left side of a screen, and a number of vertical response lists that are arrayed to the right of the list of themes. Each of the response lists includes one of the responses previously provided by the user, as well as a number of other responses that were not provided by the user. A user can proceed to quickly confirm their set of responses for a particular theme by simply moving the cursor over the theme and the correct response in each of the response lists.

Subsequent authentication (or recognition) sessions will require the user to repeat a response pattern for one of the stored themes for which they have previously generated a set of responses. Responses that the user has previously entered can be shown within a set of distracter items. The security level of this authentication session can vary depending on the sensitivity of the information being protected. Similarly, the input of information can be varied to include keystrokes, mouse clicks or more simply, mouse-over events. Once authenticated, users can further augment their login security by increasing the amount of information input on the current theme, or by developing a new, previously undeveloped theme.

In some embodiments, a user may be authenticated even though they have not exactly replicated their previous responses in an authentication session. For example some response errors of the user may be a result of an entry error (e.g., clicking the mouse too quickly), rather than a result of not knowing the correct response. Situations where the user correctly remembered the response, but made an entry error, may be taken into account by the system during an authentication session. One technique to identify such an error is to determine whether a response entered by the user is directly adjacent to the correct response in the list of potential responses that are presented to the user. A user selecting a small number (e.g., one or two) of responses that are adjacent to the correct response during an authentication session may still be authenticated. Alternatively, each response in a list of responses that are presented to a user may have a weighting factor associated with the response. The weighting factor is a probability that the response, if selected, would tend to indicate that the responding user is the same user as that reflected in the user profile. The weighting factor may be based on the similarity of the responses (e.g., the responses “beach” and “seashore” are similar) or the proximity of the responses in the response list (e.g., responses adjacent to the correct response would have a greater weighting factor than responses are located far apart). The correct response in the list of responses would have a weighting factor of “1.” The weighting factors of all responses given by a user in an authentication may be averaged, summed, or otherwise taken into account by the system when determining whether to authenticate the user. Depending on the desired level of security, perfect or less than perfect responses by a user may be required to authenticate the user.

### III. Example of Initialization Phase

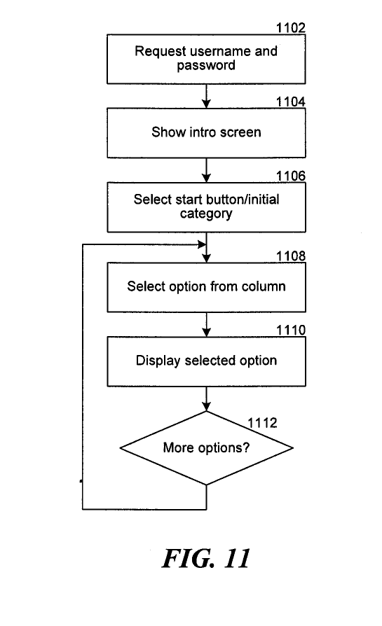

One example or embodiment of the invention will now be described in connection with suitable display screens shown in FIGS. 3-10, and the flow chart of FIG. 11. An initial, optional login step may first be performed that requests, for example, the user's name and password (block 1102 of FIG. 11). Thereafter, an initialization phase begins, where the system displays an intro screen, such as that shown in FIG. 3 (block 1104). A percentage of users will not read the initial instructions to the initialization session and therefore, the information presented is preferably brief, and direct. Each word may be chosen to inform and engage the user as much as possible. Users will become informed about this new process of authentication mostly by using it.

As shown in FIG. 3, only four themes are shown. These four themes are randomly selected by the server 208 from a database 210 containing multiple themes and presented to the user computer 202 (or other device) in the initialization phase. Themes may be a life event that the user has personally experienced, a category of information that is well known to the user, a well-known event that the user is likely familiar with, or any other category of information that the user would be able to consistently recollect. In subsequent sessions, new themes are gradually introduced to users as they are needed to enhance the security of their account. New themes are generated by the system operator and empirically tested before being utilized by the system. A significant number of themes is not required in order to achieve a relatively secure system, and a system may contain no more than ten or twenty total themes to achieve a desired level of customization and security. Examples of themes related to events include listening to music, dating, volunteering, buying something expensive, a family dinner, a party, a personal achievement, and so forth. To aid a user's selection, each theme may be consistently presented in a different color to the user. The system then receives from the user the user's selection of one of the displayed themes (block 1106).

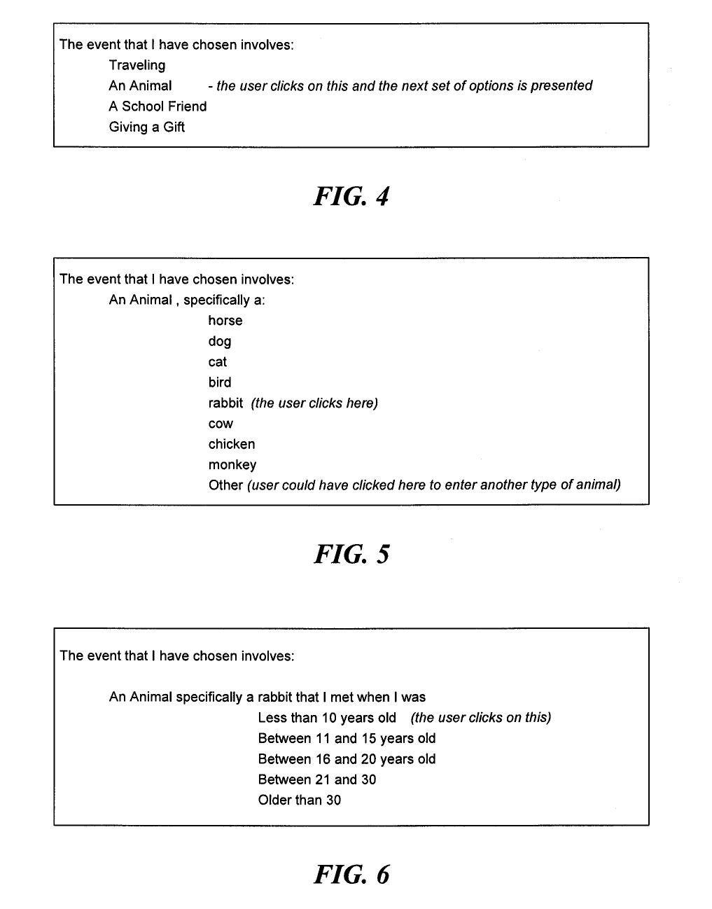

The following example assumes that that the theme “An Animal” was chosen in FIG. 3. The process is the same regardless of which theme was selected. Following selection of a theme, a user is presented with a series of questions related to that theme, each question including a limited list of responses that the user may select. The user is asked to use his or her mouse to select one response from each list that best answers the associated question, such as who, what, when, where and why (blocks 1108-1112). The system may require that the user repeat the response process twice for each selected theme to ensure that the user recalls the theme and the associated correct responses. The sequence of screens in FIG. 4 through 11 show an example of how the screens change as the user inputs information. The entire process may be very quick and easy to follow.

The number of themes and the number of questions associated with each theme is determined by the system operator, and may be expanded as new themes and questions are identified or contracted as certain themes or questions are found to not perform as well as others when measured by user recollection of the events. Themes and questions may be empirically tested by the system operator before being utilized by the system. For certain themes, only five to six questions may be necessary to achieve a desired level of security, while for other themes a greater number of questions may be required.

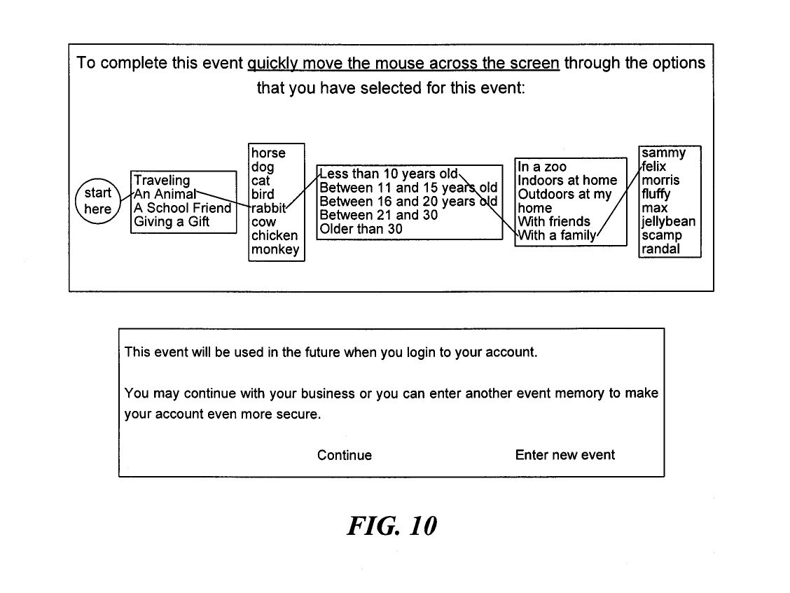

As shown in FIG. 9, at any point in the initialization stage the user may be given a summary of previously entered responses. As shown in FIG. 10, the system may also implement a confirmation step where the user is asked to confirm the previous responses that they entered. The user is shown a vertical list of themes on the left side of a screen, and a series of response lists that are arrayed to the right of the list of themes. Each of the response lists includes the response previously provided by the user, as well as a number of other responses that were not provided by the user. A user can quickly confirm their set of responses for a particular theme by simply moving the cursor over the theme and the correct response in each of the response lists. The lines shown in FIG. 10 would not necessarily be illustrated on a display to the user, but merely indicate a path that the user's mouse takes. As the user passes each list entry, the selected entry from each column may be highlighted in some fashion to enforce correct recall (e.g., bolded, underlined, blinking, different color, or otherwise).

A user's profile created during the initialization phase can be augmented on future occasions by having the user enter specific information providing additional detail about the theme, such as discussing an event related to the theme in more detail, discussing other people they met while at an event related to the theme, etc. Alternatively, users could choose to begin developing another related or unrelated theme.

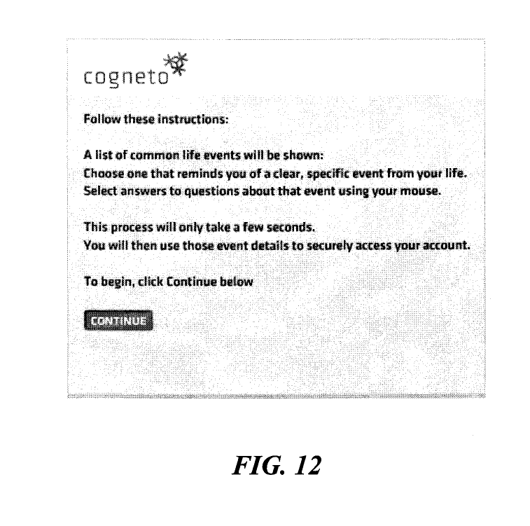

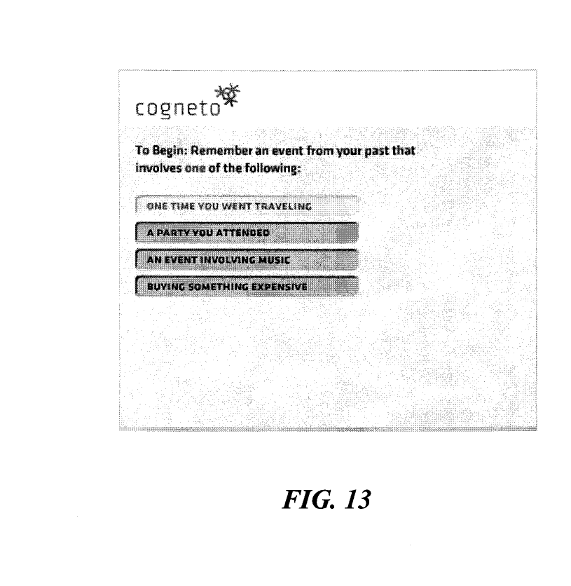

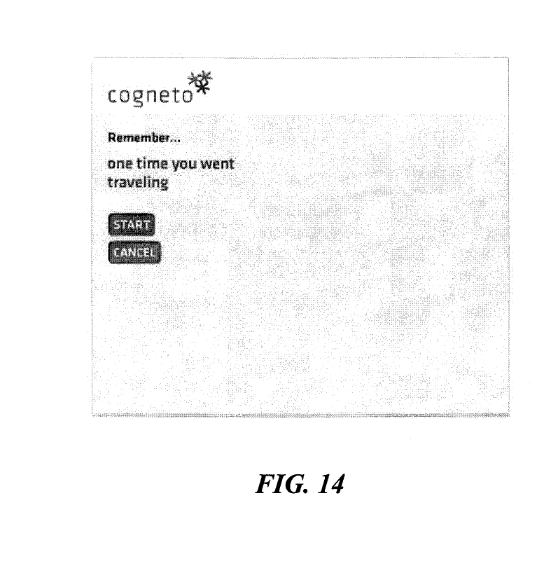

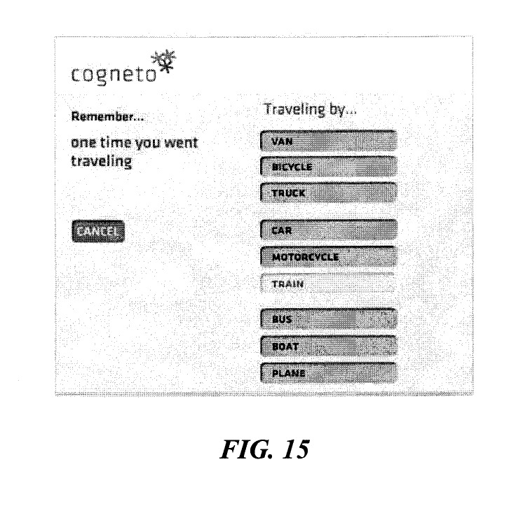

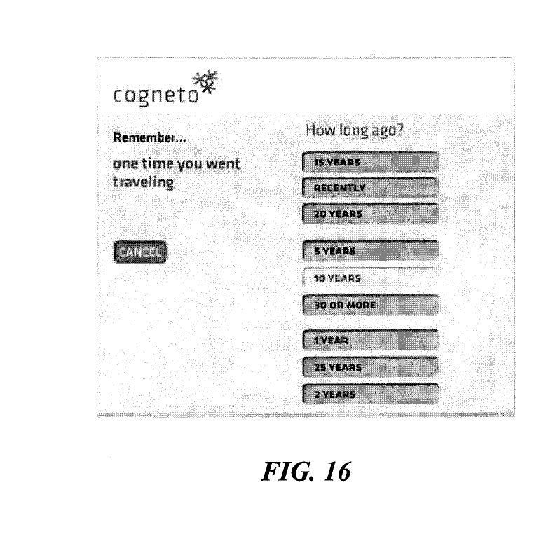

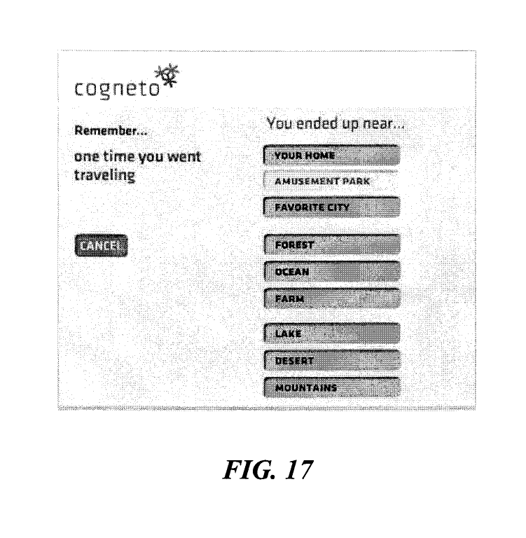

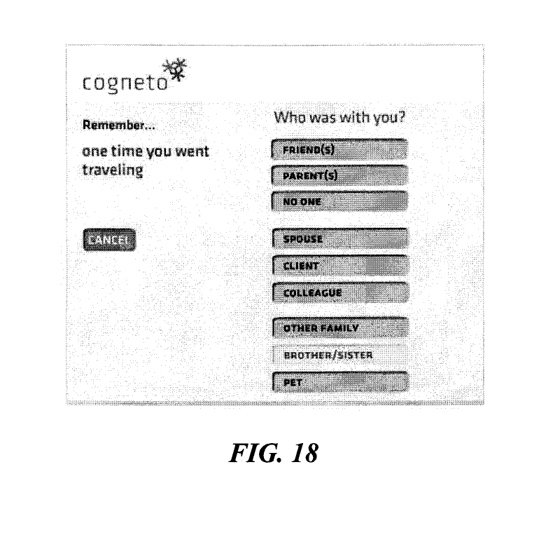

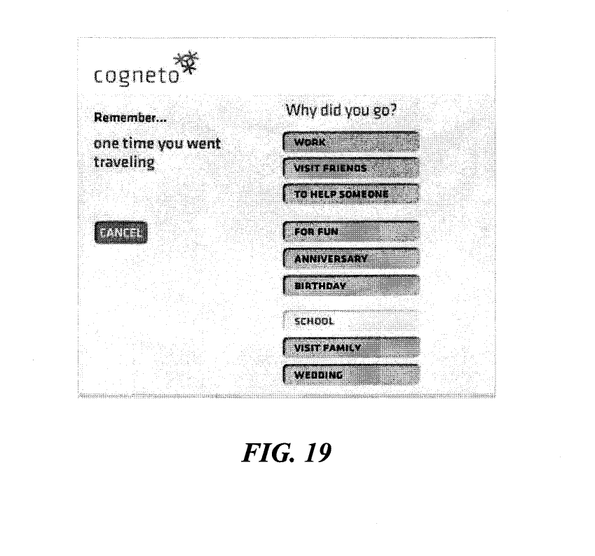

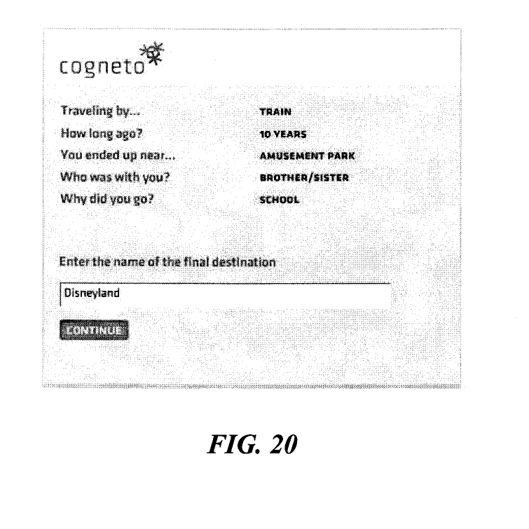

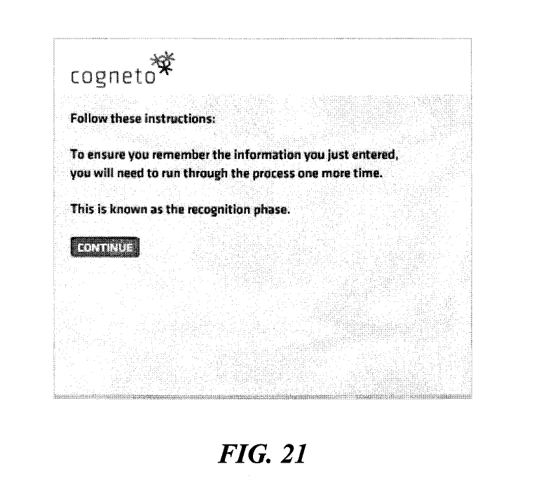

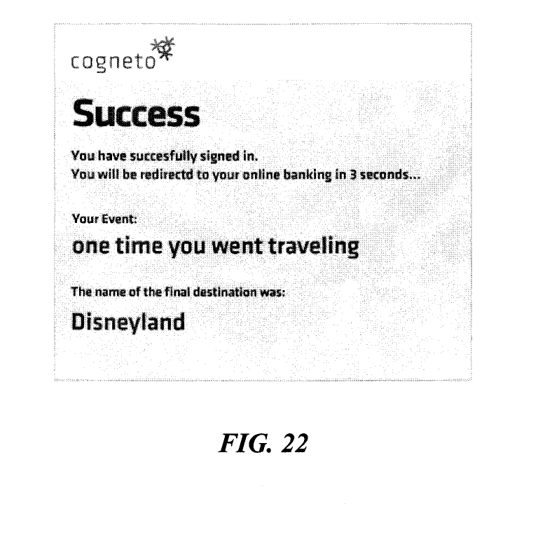

FIGS. 12-22 show an alternative series of screens that may be employed under the present system. The screens of FIGS. 12-22 are self-explanatory, particularly in light of the description above. For example, FIG. 12 shows a screen of some initial explanatory text. This screen could also explain to users that after they have entered details for a selected theme, they will be asked to re-enter the details as a confirmation that the user is accurate at re-entering details. FIG. 21 shows an example of a screen preceding the confirmation step (referred to as the “recognition phase”). Subsequent screens (not shown) would be similar to the screens of FIGS. 13-19 (but possibly with the screens in a different order, or with other choices per screen). After successfully completing the confirmation step a user would be presented with a success screen, like that of FIG. 22. If they failed, they would be presented with an “access denied” screen (not shown), and may be allowed to perform the confirmation step one more time.

As discussed above, in the initialization phase the system presents a subset of themes to the user out of a larger set of themes that could be presented by the system. The selected themes may be randomly selected, selected based on known or predicted characteristics of the user, or based on characteristics of the resources that are to be accessed after authentication by the system. After a theme has been selected in the initialization phase, individual queries related to the user's chosen theme are presented to the user. The order of the queries can be randomly selected to preserve an inherent novelty to the user at each initialization phase (and later authentication session). Alternatively, the queries can be presented in a predetermined order by the system operator. The queries allow users to relive specific aspects of their chosen theme, for example, a “who” query may ask users about people involved in an event related to the theme.

### IV. Subsequent Authentications, Alternatives, Etc.

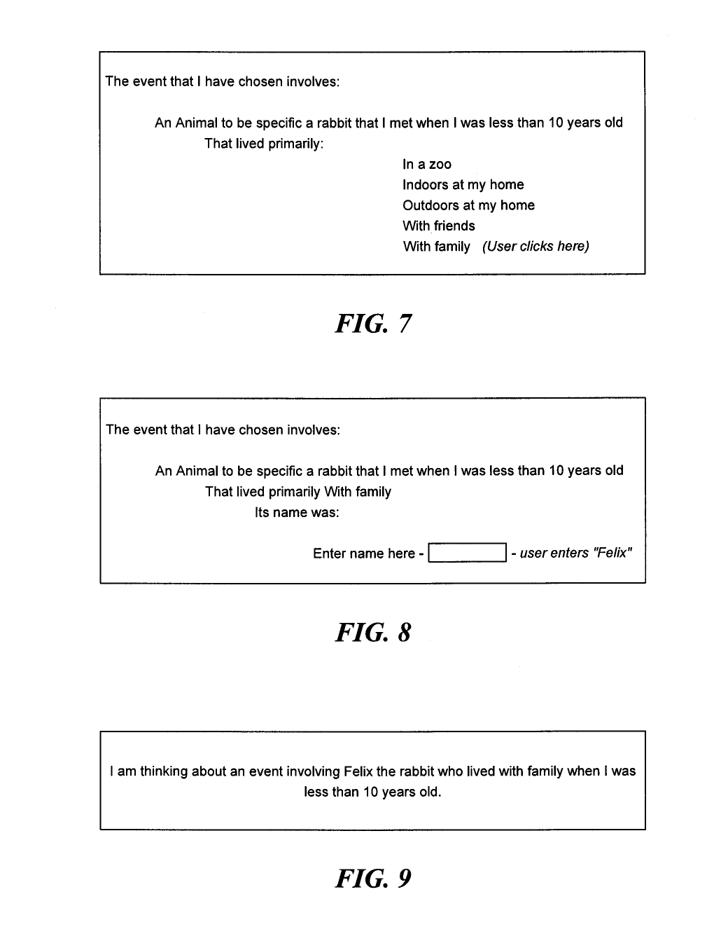

On subsequent logins, in order to be authenticated to access the system a user may be asked by the system to accurately trace a path that contains their previous responses. Alternatively, the user may be required to answer a series of questions in the same or similar format to the manner that the questions were presented in the initialization phase. Some users may have completed the initialization phase more than once, and have stored responses to a number of themes in their profile. In these cases, the system will automatically, and randomly, select one of the themes to be displayed from the set of themes within a user's selection history, and display this theme among a set of other, non-selected themes. The non-selected themes act as a “distractor set.”. Only the particular user will know which theme to select at login, and how to answer the corresponding queries on each series of corresponding screens. Distractors are also introduced into each list of potential responses to the queries. Distractors are often different, yet plausible, answers to the queries. Further distractors to be presented could include, for example, sets of potential responses being presented in different orders (e.g., FIG. 6 responses are provided before those of FIG. 5), different responses within each column of responses (e.g., additional or alternate responses to those shown in FIG. 7, except that the “with family” correct response is still provided), and so forth.

In general, when presented with the same question at different times, individual users may respond with different answers. For example, one user may respond with “a friend” on one occasion, but on a subsequent occasion answer using that friend's first name, family name, etc. To reduce the possibility of variability in responses from a given individual, thereby enhancing accurate user performance, the system presents to the user a finite list from which to select a response. This finite list is designed to serve at least three functions. First, it forces users to spend a small amount of time to find one of the displayed options that most closely approximates that user's response to the theme. The system may store the time to respond for the user. This forced choice selection task enhances security since a non-user would not immediately know the exact response to what the user entered, even if that non-user was closely-related to or familiar with the user. Thus, a non-user would take longer to respond, and the system can distinguish a non-user from the user based on the time difference in responding between the user and non-users.

A second function of presenting a finite list of potential responses is to restrict accurate performance to a recognition task, as opposed to a recall task. While recognition tasks have been shown to allow stable responses over decades, even a lifetime, recall performance degrades quickly. A user who chooses to share his information with someone he trusts will have a low probability of accurately recalling the exact options from each finite list for that whole theme, and thus will have difficulty sharing that information.

A third function of presenting a finite list of potential responses is to allow the user to know exactly what to expect during the authentication session. Replaying the exact form of the task for the purpose of recognition allows the user to develop a stable learning pattern over successive attempts. The first time users enter their information for a theme, they show relatively slow response performance. Over the course of numerous trials, they develop proficiency with the task, which manifests itself as a stable response time learning curve. This curve will be unique for each theme and each user, and that stability allows for an analytic engine to produce a reliable, valid estimate for future performance. Further details regarding such an analytic engine is found in U.S. Patent Application No. 60/797,718, filed May 4, 2006 (attorney docket no. 60783.8002.US00), entitled, “System and Method for Enhancing User Authentication Through Estimation of Future Response Patterns.”

Overall, with repetition, users will move from a recall based response (where they must remember the choices and options), to a recognition response where each user can respond quickly based on increased experience with the user interface. Thus, it may be difficult for a given user to tell someone else how to respond appropriately without viewing or interacting with the user interface itself.

After the initial session, a user may be permitted to develop one new theme, or further develop one previous theme, during subsequent logins. New theme development is similar in structure to the initialization session noted above, which helps develop a user's profile of chosen themes and user responses. Development of previous themes allows for additional authentication of the user and for enhancement of the information previously collected. Advantageously this process allows the system to present on future occasions a randomly selected theme for authentication and refinement, eliminating the predictability of future login, a characteristic of most current authentication technologies that is often capitalized on by non-user security threats.

The system provides for strong security without requiring repetitive “training,” which is common in many biometric systems. For example, with fingerprint recognition systems, a user may be required to perform twenty or more fingerprint impressions before a biometric fingerprint security system obtains enough data to provide accurate security. Other systems can be even more onerous, such as keyboard entry systems. Moreover, the present system provides a more enjoyable training experience, because users are asked to recall a fond memory. Indeed, the present system can provide accurate security with only two steps, namely initialization, and then authentication. If higher security is needed, such as when users are logging in from a different computer or from a different country than they usually do, they may be asked to trace part of the path, then enter information to complete the authentication (e.g., they could be asked “what is Felix?”, “what is the animal's name?”, etc.). Alternatively or additionally, the user may be required to repeat the same series of authentication steps, but for a different theme selected from his or her profile.

The system thus defines multiple categories or themes, and stores results, not only initially, but upon subsequent authentication sessions. Correct answers and distractors are assigned to themes or categories. Using as an example a mobile phone, a user of a new phone will first perform the initialization phase noted above to secure the phone and prohibit unauthorized access to the phone. The user's answers are stored within the phone. During later authentication sessions, the phone will periodically or occasionally present one or more new themes and associated questions to develop a diary or database of user responses to be used in later authentication sessions.

Probability of penetration of a user's account by a non-user can be quantified using this system. An upper bound of the expected gross probability is a product of the number of response sets presented, each raised exponentially by the number of options in each set, and finally multiplied by the probability of supplying the exact keyword or other information at session end.

A lower bound of the expected gross probability of penetration can be less easily quantified, though it may be many factors lower than the upper bound. The amount of data collected during the initialization phase allows for this system to be augmented by additional systems that analyze the pattern information to either augment authentication requirements or to modify the presentation of information (e.g., by adding additional distracters).

On most login occasions users will not be required to enter new information. At regularly scheduled intervals, however, users will be reminded that adding new information will strengthen the security of their account and be given a set number of days to do so, after which they will not be allowed access to their account without adding a new theme or further developing an existing theme.

As noted above, the system may record multiple forms of information about a user's interaction with the system, including periodic X/Y coordinates of cursor movement and keystroke generation patterns. The system can also record any additional information provided by a computer or data processing platform utilized by a user, such as a computer ID, commonly used IP address, etc. This data may then be used to provide further authentication and security, such as employed in the system describing U.S. Patent Application No. 60/797,718, filed May 4, 2006 (attorney docket no. 60783.8002.US00), entitled, “System and Method for Enhancing User Authentication Through Estimation of Future Response Patterns.” Further, the system can record thematic choice patterns by a user to help, for example, provide additional future thematic choices as a user develops a profile of responses and response patterns. For example, if a user selected “listening to music” and “dating” theme choices, these choices represent a person who may be socially aware, and thus a future choice to provide to that user may be a theme based on past family events.

While the examples depicted in the figures primarily rely on a text interface to convey information to the user and receive responses from the user, those skilled in the art will appreciate that other interface mechanisms may be equally applicable and in some cases preferable for the system. For example, images, pictures, or other graphic icons may be used to represent themes, events, questions, and responses. Alternatively, and particularly in devices with small screens such as mobile phones, speech synthesis and voice recognition technologies may be used to exchange themes, events, questions, and responses with a user. Those skilled in the art will appreciate that the system may be directly operated by the party that desires a secure log-in process, or may be operated as a service for parties desiring a high degree of security.

### V. Conclusion

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes are presented in a given order, alternative embodiments may perform routines having steps in a different order, and some processes may be deleted, moved, added, subdivided, combined, and/or modified. Each of these processes may be implemented in a variety of different ways. Also, while processes are at times shown as being performed in series, these processes may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference, including U.S. Pat. No. 11/161,116, filed Jul. 22, 2005, entitled “Memory Based Authentication System,” by inventors David Eppert and Martin Renaud. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A method of authenticating a user for access to a network, wherein the authentication method avoids the need for specialized authorization hardware, the method comprising:
in an initialization session:
presenting a user with multiple categories, wherein the multiple categories are related to life events that the user may have experienced;
receiving a selection from the user of one of the multiple categories;
based on the selected category, presenting multiple queries to the user, wherein each of the multiple queries is related to the selected category and each of the multiple queries is presented with multiple possible responses to the query; and
for each of the multiple queries, receiving a response selected from the multiple possible responses from the user and storing the received response in a profile of the user; and
in an authentication session:
presenting the multiple queries related to the selected category to the user, wherein each of the multiple queries is presented with multiple possible responses to the query including the response to the query received from the user in the initialization phase;
for each of the multiple queries, receiving a response selected from the multiple possible responses from the user; and
authenticating the user if the received response to each of the multiple queries matches the response to each of the multiple queries stored in the profile of the user.

2. The method of claim 1, further comprising repeating the initialization session for two or more different selected categories for each user.

3. A computer-readable medium storing computer-executable instructions that provides an electronic access security method, wherein the electronic access security method avoids the need for specialized authorization hardware, the method comprising:
posing multiple categories to a user, wherein each category relates to a personal event that the user may recall;
receiving a selection of one of the personal event categories;
storing the received selection of the one personal event category;
providing several questions for the selected personal event category, wherein each question includes multiple corresponding choices;
receiving selected choices for each of the several questions; and
storing the received choices of the one of the multiple choices, wherein the stored received selection and received choices are associated with the user.

4. The computer-readable medium of claim 3, further comprising: posing new multiple categories that do not include the stored received selection, and repeating the receiving a selection, storing the received selection, providing multiple choices, providing several questions, receiving selected choices and storing the received choices.

5. The computer-readable medium of claim 3, further comprising: authenticating a user by providing a selected set of multiple personal event categories, several questions, and multiple corresponding choices, and comparing received selections to the stored received selection and received choices.

6. The computer-readable medium of claim 3, further comprising: developing a stored set of responses to a user's selection of multiple different personal event categories and corresponding selected choices during different sessions.

7. The computer-readable medium of claim 3 wherein the posing of multiple categories includes randomly selecting the multiple categories from a larger set of categories.

8. The computer-readable medium of claim 3 wherein the providing of several questions includes presenting the questions and multiple corresponding choices as a displayed two-dimensional grid from which the user may make selections.

9. The computer-readable medium of claim 3, further comprising: receiving alphanumeric input to a question and storing the received alphanumeric input.

10. The computer-readable medium of claim 3, further comprising: receiving and storing computer identification value, IP address, cursor movement patterns from computer input devices, keystroke generation patterns from keyboards, or thematic choice patterns from chosen personal event categories.

11. The computer-readable medium of claim 3, further comprising: presenting information during authentication, including:
presenting a selected set of multiple personal event categories, several selected questions, and multiple corresponding choices, wherein the selected set of multiple personal event categories, several selected questions, and wherein the multiple corresponding choices presented include the stored received choices with different but plausible alternative choices.

12. The computer-readable medium of claim 3, further comprising:
receiving and storing response time values for the user, and
upon subsequent authentication, presenting several selected questions with multiple corresponding choices, and comparing times to respond to the several selected questions to the stored response time values.

13. A system to authenticate a user, the system comprising:
at least one user input portion;
at least one memory storing instructions;
at least one output portion; and
at least one processing portion coupled to the input and output portions, and coupled to the memory to execute the instructions stored in the memory, wherein the instructions configure the system to:
present multiple categories to a user via the output portion, wherein each category relates to a personal event that the user may recall;
receive via the input portion a user selection of one of the personal event categories;
store in the memory the received selection of the one personal event category;
provide via the output portion several questions for the one selected personal event category, wherein each question includes multiple corresponding answers;
receive via the input portion user-selected answers for each of several questions associated with the one selected personal event category; and
store in the memory the received answers for each of the several questions associated with the one selected personal event category, wherein the stored received selection and the stored received answers are stored as being associated with the user.

14. The system of claim 13 wherein the input portion includes an audio input device, wherein the output portion includes an audio output device, and wherein at least the several questions or multiple corresponding answers are presented audibly via the audio output device.

15. The system of claim 13 wherein the system is an automated teller machine (ATM), portable computer, or phone.

16. A security system, comprising:
means for posing multiple categories to a user, wherein each category relates to an experience to be recalled by the user;
means for receiving a selection of one of the personal event categories;
means for storing the received selection of the one personal event category;
means for providing several questions for the one selected personal event category, wherein each question includes multiple corresponding choices;
means for receiving selected choices for each of the several questions; and
means for storing the received choices of the one of the multiple choices, wherein the stored received selection and received choices are associated with the user.

17. The system of claim 16, further comprising: means for posing new multiple categories that do not include the stored received selection, and means for repeating the receiving a selection, storing the received selection, providing multiple choices, providing several questions, receiving selected choices and storing the received choices.

18. The system of claim 16, further comprising: means for authenticating a user by providing a selected set of multiple personal event categories, several questions, and multiple corresponding choices, and means for comparing received selections to the stored received selection and received choices.

19. The system of claim 16, further comprising: means for developing a stored set of responses to a user's selection of multiple different personal event categories and corresponding selected choices during different sessions.
